(19) United States
(12) Patent Application Publication
(10) Pub. No.: US 2014/0222538 A1
(43) Pub. Date: Aug. 7, 2014

(54) CUSTOMER EXPERIENCE MANAGEMENT FOR AN ORGANIZATION

(71) Applicant: korl8, Inc., Seattle, WA (US)

(72) Inventors: Eric S. Merrifield, JR., Seattle, WA (US); Manuel Vellon, Bellevue, WA (US); Mark D. Hadland, Newcastle, WA (US)

(73) Assignee: korl8, Inc., Seattle, WA (US)

(21) Appl. No.: 14/174,831

(22) Filed: Feb. 6, 2014

Related U.S. Application Data
(60) Provisional application No. 61/762,023, filed on Feb. 7, 2013.

(51) Int. Cl. G06Q 30/02

(52) U.S. Cl. CPC G06Q 30/0224
USPC 705/14.25

(57) ABSTRACT

The present invention extends to methods, systems, and computer program products for customer experience management for an organization. Embodiments of the invention can be used to monitor and analyze customer activity. From larger volumes of data, data can be concentrated to identify events with higher relevance to customer or guest experiences with the organization. Data can be correlated with customer or guest experiences to provide more personalized experiences in the future. Embodiments include event processing rules. Event processing rules can be used to provide more intelligent rewards to customers or guests. Event processing rules can also be used to synthesize other events. Embodiments can apply data analytics at a range of organizational levels (e.g., operator to management level) to improve customer or guest experiences. Embodiments can provide visualizations to an organization to present correlated trend data about customers or guests.

### CROSS-REFERENCE TO RELATED APPLICATIONS

This application claims the benefit of and priority to U.S. Provisional Patent Application Ser. No. 61/762,023, entitled “Customer Experience Management For An Organization”, filed Feb. 7, 2013 by Eric S. Merrifield, JR. et al., the entire contents of which are expressly incorporated by reference.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

There are many business and other organizations that exist within the United States and throughout the world. Any one of these may include a few to several thousand or even hundreds of thousands of employees. Furthermore, many organizations include many different sub-organizations and departments that produce a wide variety of products and/or services. Additionally, these organizations may have facilities and employees that are distributed in many different locations throughout a country or the world.

Most if not all organizations use computer systems at least to some extent to assist with monitoring and improving customer or guest management experiences. However, based on one or more of: size, varied geographic locations, available intra-organization communication mechanisms, and other factors, organizations often have a number of difficulties when formulating customer experience or guest experience strategies. In general, organizations can have a difficult time determining whether they are providing an appropriate level of service and/or products to their customers. For example, given the size of some large scale corporations, it may be difficult to track all of a customer's interactions and make data associated with those interactions available in a companywide manner. Another difficulty is determining whether changes in a particular part of an organization (e.g., a department, divisions, etc.) actually improve customer or guest experiences with the organization.

Additionally, for organizations of most any size, relatively large volumes of data can be collected for customers or guests. Due to the large volume of data, it can be difficult to process and analyze the data to identify portions of the data that may be more relevant to monitoring and/or improving customer or guest experiences. In some environments, different types of data are stored in different silos. Data siloing can make it difficult to integrate data and provide a fuller picture of a customer or guests experience with an organization.

### BRIEF SUMMARY

The present invention extends to methods, systems, and computer program products for customer experience management for an organization. Embodiments of the invention include determining customer benefits based on customer events. Customer data is accessed from one or more customer inputs. The customer data is concentrated into one or more relevant customer events. One or more synthetic events are formulated from the one or more relevant events. An intelligent reward is derived for at least one customer based on the one or more relevant events. The one or more synthetic events and the intelligent reward are stored in a database.

Embodiments of the invention also include determining customer recommendations based on customer events. Customer data is accessed from a database. The customer data represents individual events for one or more customers of a customer base. Analysis results are generated by analyzing the accessed data using one or more of: a customer experience index, data mining, and ad hoc queries.

Trend data is formulated for a plurality of different segments of the customer base from the analysis results. The customer base is segmented using a multi-variable algorithm based on the values for a plurality of different variables provided to the multi-variable algorithm. A recommendation is provided for at least one customer based on individual events and trend data for the at least one customer. The at least one customer is selected from among the one or more customers of the customer base. The recommendation is stored in a database.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates customer experience management for an organization.

FIG. 2 illustrates a flow chart of an example method for determining a customer reward.

FIG. 3 illustrates an example computer architecture that facilitates customer experience management for an organization.

FIG. 4 illustrates a flow chart of an example method for determining customer recommendations based on customer events.

FIG. 5A illustrates an example computer architecture of a customer experience management (CEM) information pipeline.

FIG. 5B illustrates another example computer architecture of a customer experience management (CEM) information pipeline.

FIG. 6 illustrates an example computer architecture of a customer experience management (CEM) platform.

FIG. 7 illustrates an example visualization of customer data.

FIG. 8 illustrates an example of a three dimensional graph segmenting customers using a multi-variable algorithm.

### DETAILED DESCRIPTION

The present invention extends to methods, systems, and computer program products for customer experience management for an organization. Embodiments of the invention include determining customer benefits based on customer events. Customer data is accessed from one or more customer inputs. The customer data is concentrated into one or more relevant customer events. One or more synthetic events are formulated from the one or more relevant events. An intelligent reward is derived for at least one customer based on the one or more relevant events. The one or more synthetic events and the intelligent reward are stored in a database.

Embodiments of the invention also include determining customer recommendations based on customer events. Customer data is accessed from a database. The customer data represents individual events for one or more customers of a customer base. Analysis results are generated by analyzing the accessed data using one or more of: a customer experience index, data mining, and ad hoc queries.

Trend data is formulated for a plurality of different segments of the customer base from the analysis results. The customer base is segmented using a multi-variable algorithm based on the values for a plurality of different variables provided to the multi-variable algorithm. A recommendation is provided for at least one customer based on individual events and trend data for the at least one customer. The at least one customer is selected from among the one or more customers of the customer base. The recommendation is stored in a database.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Within this specification and in the following claims, “Customer Experience Management” (CEM) is defined as the collection of processes an organization (e.g., a business) uses to track, oversee, and organize interactions between a customer and the organization throughout the customer lifecycle. Interactional CEM can be used to capture customer experience data. CEM is activity-based and can be used to view what a customer is doing. Mobile technology and social networking can be used to feed CEM modules. CEM can be used to increase individual customer experiences significantly.

For example, embodiments of the invention can be used to monitor and analyze customer activity. From larger volumes of data, data can be concentrated to identify events with higher relevance to customer or guest experiences with the organization. Data can be correlated with customer or guest experiences to provide more personalized experiences in the future.

Embodiments include event processing rules. Event processing rules can be used to provide more intelligent rewards to customers or guests. Event processing rules can also be used to synthesize other events. Embodiments can apply data analytics at a range of organizational levels (e.g., operator to management level) to improve customer or guest experiences. Embodiments can provide visualizations to an organization to present correlated trend data about customers or guests.

Accordingly, embodiments of the invention can be used to centralize relevant customer or guest data, track customer activity with increased granularity, facilitate the delivery of rewards, and provide useful out-of-box analytics.

A mutli-variable algorithm, including variables, such as, for example, experiences, profitability, and frequency, can be used to monitor a customer or guest experience. Variables can be weighted differently to enable organizations to set rules based on a score computed by the multi-variable algorithm. Organizations can decide when and/or where to spend time and money to influence variables such as profitability and frequency.

Customer activity can include location, survey results, customer relationship management data, and point of sale data. From the customer activity, data concentration can be used to identify more relevant data form within a larger volume of data.

Awareness of negative experiences can allow for recovery. In some embodiments, a customer uses an organization's application (“app”) on a mobile device, for example, to indicate the customer's location (e.g., within an airport). The organization can monitor the location of multiple customers that are using the application simultaneously. Monitored customers can be classified into different types, indicating profitability, frequencies, etc. (e.g., by frequent flyer status). From within the location data, the organization can track state changes for customers (there is no need to know “every move” of each customer). When a bad experience occurs (e.g., a flight is cancelled), a group response, such as, “your flight is cancelled”, can be sent to impacted customers. Alternately, a targeted response, such as, “your flight is cancelled, free upgrade next time”, can be sent to specified types of customers (e.g., more profitable customers).

Thus, data concentration can be used to process high volumes of data by filtering out other data to identity state change data. Group and/or targeted messages can be sent in response/reaction to an event. Using a multi-variable algorithm with weighted variables, each organization can configure their own business rules.

Event processing rules can be used to provide intelligent rewards (e.g., offer status upgrade if a customer buys one more ticket) and formulated synthetic events (e.g., upgrade airline customer). An intelligent reward can be based on a customer taking an action (e.g., buy one more ticket) to obtain a benefit (e.g., status upgrade). A synthetic event can be a benefit (e.g., upgrade from coach to first class) that is given without customer action.

Awareness of customer's history can be used to show trends. Customers near tier levels can be up-sold. For example, when a customer is close to a next tier, an offer can be provided to get them to make a purchase and become the next tier status. Former top tier customers can be upsold. For example, for a former top tier customer, an offer can be provided to make a purchase and go back to top tier status. Visibility into profitable customers can “auto” trigger events, such as, free upgrades. Visibility into customer profitability can help organizations be smarter about investing in profitable customers.

A configurable events rules engine can be used to provide intelligent rewards and formulate synthetic events. Events can be free or cost based on rules. Correlating results/response from events enables tuning by customer “type.”

Customer experience is a variable visible to an organization's personnel. Line managers can see individual events and respond based on business rules. Managers can see group and trend data and respond accordingly and/or adjust rules. Different data can be provided for customer facing personnel and management. Management can modify business rules based on data. Correlation and cause and effect data with reactions/rewards can be captured.

Real time and/or trend data can be presented. Time lapse data can be viewed to visualize customer behavior. Customers can segmented, for example, by profitability or demographics, to see the behavior of different segments of the customer base. Showing different segments of customers can help optimize customer experience and profit. Visualizations can be tied into social networking to expand an organization's relationships.

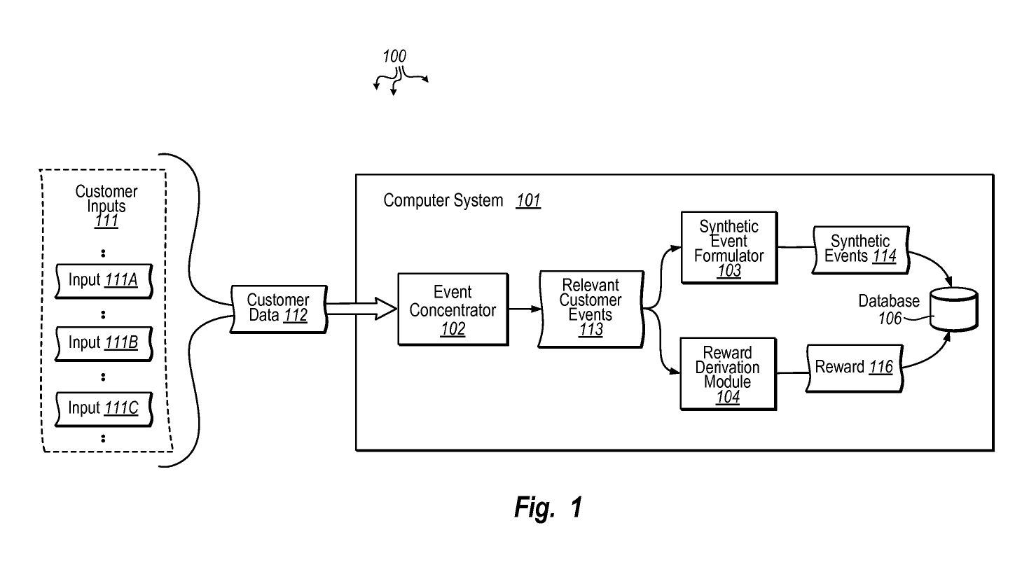

FIG. 1 illustrates an example computer architecture 100 that facilitates customer experience management for an organization. Referring to FIG. 1, computer architecture 100 includes computer system 101 and customer inputs 111. Computer system 101 and customer inputs 111 can be connected to (or are part of) a network, such as, for example, a Local Area Network (“LAN”), a Wide Area Network (“WAN”), and even the Internet. Accordingly, computer system 101 and customer inputs 111 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

As depicted, computer system 101 includes event concentrator, synthetic event formulator 103, reward derivation module 104, and database 106. In general, event concentrator is configured to concentrate customer data into relevant customer events. Synthetic event formulator is configured to formulate synthetic events for a customer from events that are relevant to the customer. Reward derivation module is configured to derive intelligent rewards for a customer from events that are relevant to the customer.

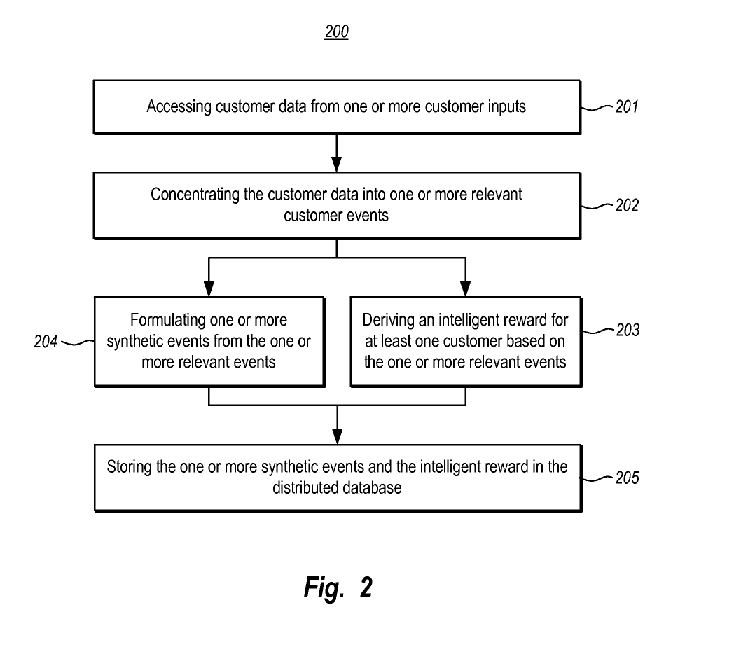

FIG. 2 illustrates a flow chart of an example method 200 for determining a customer reward. Method 200 will be described with respect to the components and data in computer architecture 100.

Method 200 includes accessing customer data from one or more customer inputs (201). For example, computer system 100 can access customer data 112 from customer inputs 111, including inputs 111A, 111B, and 111C. Method 200 includes concentrating the customer data into one or more relevant customer events (202). For example, event concentrator 102 can concentrate customer data 112 into relevant customer events 113.

Method 200 includes formulating one or more synthetic events from the one or more relevant events (203). For example, synthetic event formulator 103 can formulate synthetic events 114 from relevant customer events 113. Method 200 includes deriving an intelligent reward for at least one customer based on the one or more relevant events (204). For example, reward derivation module 104 can derive reward 116 from one or more of relevant customer events 113. Method 200 includes storing the one or more synthetic events and the intelligent reward in the database (205). For example, synthetic event formulator 103 can store synthetic events 114 in database 106. Similarly, reward derivation module 104 can store reward 116 in database 106.

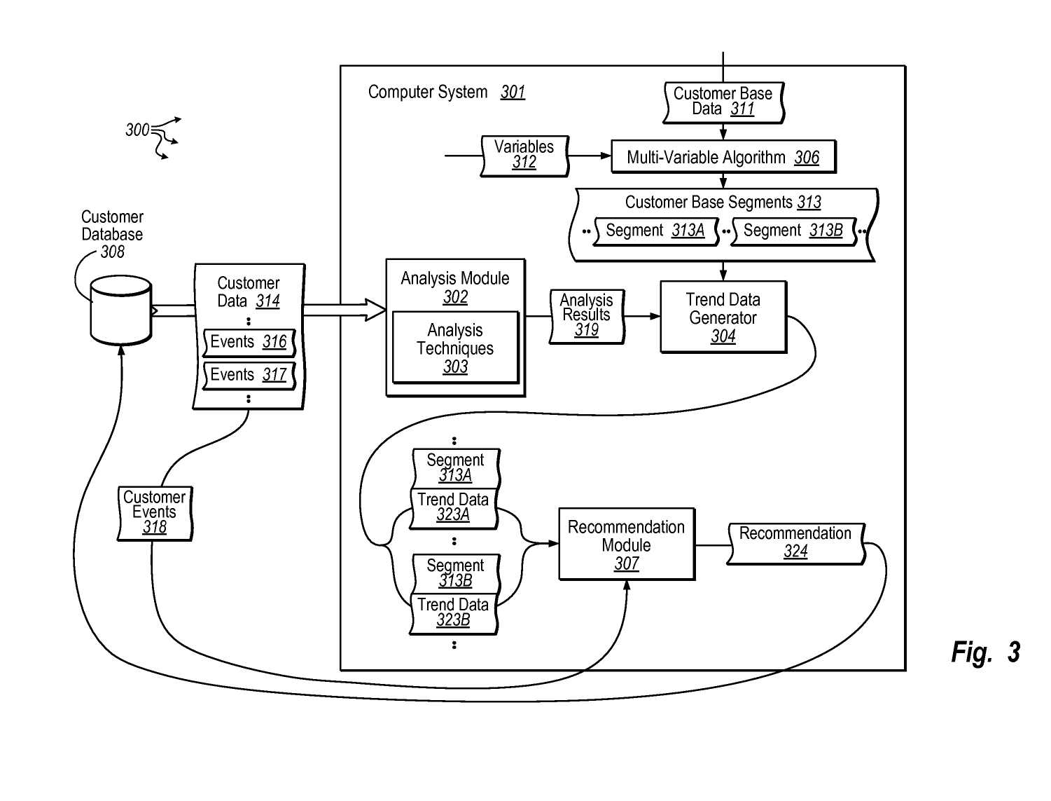

FIG. 3 illustrates an example computer architecture 300 that facilitates customer experience management for an organization. Referring to FIG. 3, computer architecture 300 includes computer system 301 and customer database 308. Computer system 301 and customer database 308 can be connected to (or are part of) a network, such as, for example, a Local Area Network (“LAN”), a Wide Area Network (“WAN”), and even the Internet. Accordingly, computer system 301 and customer database 308 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

As depicted, computer system 301 includes analysis module 302, trend data generator, mutli-variable algorithm 306, and recommendation module 307. In general, analysis module 302 can use one or more of analysis techniques 303 to analyze any of a variety of different aspects of customer data. Multi-variable algorithm 306 is configured to segment a customer base into different segments based on customer base data and variables. Trend data generator 304 is configured to generate customer trend data for different segments of a customer base. Recommendation module is configured to make recommendations to improve customer experiences based on trend data in different segments of a customer base.

Customer database 308 is configured to store customer data, including events, for a plurality of different customers.

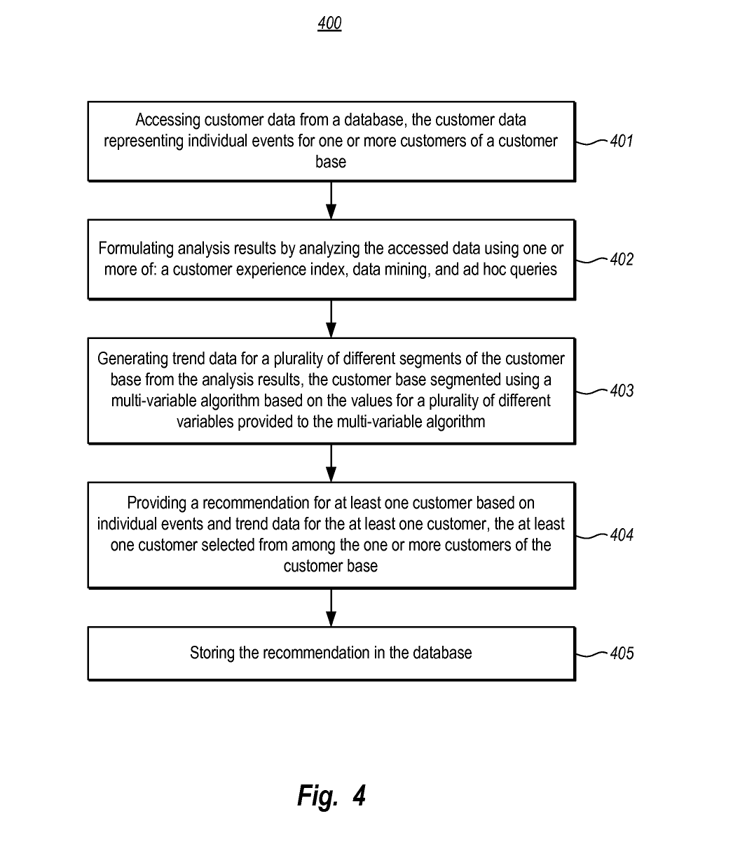

FIG. 4 illustrates a flow chart of an example method 400 for determining customer recommendations based on customer events. Method 400 will be described with respect to the components and data in computer architecture 300.

Method 400 includes accessing customer data from a database, the customer data representing individual events for one or more customers of a customer base (401). For example, computer system 301 can access customer data 314 form customer database 308. Customer data 314 can include events, such as, for example, 315, 317, etc. for one or more customers of a customer base.

Method 400 formulating analysis results by analyzing the accessed data using one or more of: a customer experience index, data mining, and ad hoc queries (402). For example, analysis module 302 can formulate analysis results 319 by analyzing customer data 324 using one or more of: a customer experience index, data mining, and ad hoc queries (implemented in analysis techniques 303).

Analysis module 302 can send analysis results 319 to trend data generator 304. Trend data generator 304 can receive analysis results 319 from analysis module 302.

Method 400 includes generating trend data for a plurality of different segments of the customer base from the analysis results, the customer base segmented using a multi-variable algorithm based on the values for a plurality of different variables provided to the multi-variable algorithm (403). For example, trend data generator 304 can generate trend data 323A for customer segment 313A and can generate trend data 323B for customer segment 313B.

Multi-variable algorithm 306 can segment a customer base into different segments. Multi-variable algorithm 306 can access customer base data 311 from customer database 308. Customer base data 311 can represent a customer base for the customers have data stored in customer database 308.

Multi-variable algorithm 306 can consider customer base data 311 and variables 312 (e.g., profitability, frequency, status, etc.) to segment the customer base into customer base segments 313. Customer base segments include segments 313A, 313B, etc. Each customer base segment can represent a segment of customers that have similar values for variables 312. For example, high profitability, high use customers can be grouped together in one customer segment. Low profitability, high use customers can be grouped together in another different customer segment.

Trend data generator 304 can send trend data for customer base segments to recommendation module 307. For example, trend data generator 304 can send segment 313A/trend data 323A and segment 313B/trend data 322B to recommendation module 307. Recommendation module 307 can receive trend data for customer base segments from trend data generator 304. For example, recommendation module 307 can receive segment 313A/trend data 323A and segment 313B/trend data 322B from trend data generator 304.

Recommendation module 307 can access customer events 318 from customer data 314. Customer events 318 can be associated with one or more customers.

Method 400 includes providing a recommendation for at least one customer based on individual events and trend data for the at least one customer, the at least one customer selected from among the one or more customers of the customer base (404). For example, recommendation module 307 can generate recommendation 324 (e.g., to give a customer free upgrade, a discount, etc.) from 313A/trend data 323A, segment 313B/trend data 322B, etc. and customer events 318. Recommendation 324 can correspond to the one or more customers associated with customer events 318.

Method 400 includes storing the recommendation in the database (405). For example, recommendation module 302 can store recommendation 324 in customer database 308.

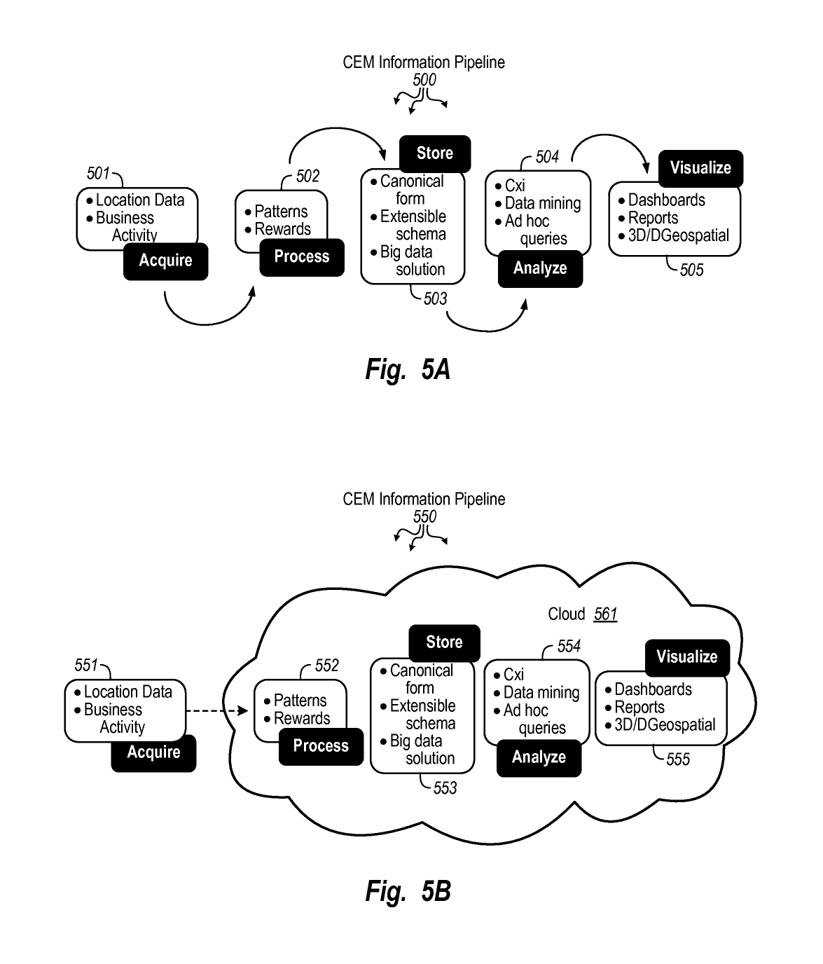

Turning now to FIG. 5A, FIG. 5A illustrates an example computer architecture of a customer experience management (CEM) information pipeline 500. CEM information pipeline 500 includes acquire module 501, process module 502, store module 503, analyze module 504, and visualize module 505. Each of acquire module 501, process module 502, store module 503, analyze module 504, and visualize module 505 can be included in a computer system and connected to one another over (or be part of) a network, such as, for example, a Local Area Network (“LAN”), a Wide Area Network (“WAN”), and even the Internet. Accordingly, each of the depicted modules as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

As depicted, acquire module 501 can acquire customer data including location data, data from business activities, and data from surveys. Process module 502 can identify patterns in customer data and offer rewards to customers based on identified patterns. Store module 503 can store data in a canonical form and in accordance with an extensible schema to provide a solution for processing larger volumes of data. Analyze model 504 can perform a Customer Experience Index (CXi) calculation, data mining, and ad how queries on stored customer data. In some embodiments, analyze module 504 can concentrate customer data. Visualize module 505 can provide dashboards, reports, and 3D/geospatial presentations of (e.g., concentrated) customer data.

FIG. 5B illustrates another example computer architecture of a customer experience management (CEM) information pipeline 550. CEM information pipeline 550 is similar to CEM information pipeline 500. CEM information pipeline 550 includes acquire module 551, process module 552, store module 553, analyze module 554, and visualize module 555. Acquire module 551, process module 552, store module 553, analyze module 554, and visualize module 555 have similar functionality to acquire module 501, process module 502, store module 503, analyze module 504, and visualize module 505 respectively. As depicted in CEM information pipeline 550, process module 552, store module 553, analyze module 554, and visualize module 555 are resident in cloud 561. Cloud 561 can be based on a cloud computing model.

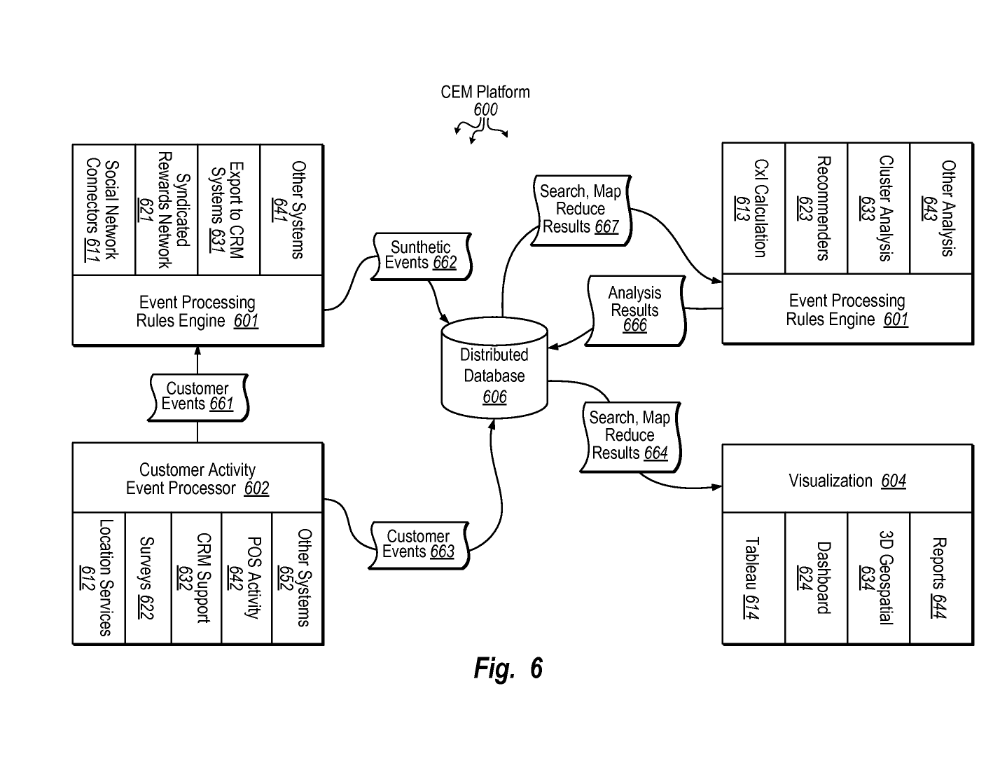

FIG. 6 illustrates an example computer architecture of a customer experience management (CEM) platform 600. As depicted, CEM platform 600 includes event processing rules engine 601, customer activity event processor 602, analytics 603, visualization 604, and distributed database 606. Each of event processing rules engine 601, customer activity event processor 602, analytics 603, visualization 604, and distributed database 606 can be included in a computer system and connected to one another over (or be part of) a network, such as, for example, a Local Area Network (“LAN”), a Wide Area Network (“WAN”), and even the Internet. Accordingly, each of event processing rules engine 601, customer activity event processor 602, analytics 603, visualization 604, and distributed database 606 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc. or using other non-datagram protocols) over the network.

Customer activity event processor 602 can acquire customer data from location services 612, surveys 622, Customer Relationship Management (CRM) module imports 632, point-of-sale (POS) system activity 642, and other systems 652. Customer activity event processor 602 can concentrate acquired customer data into customer events 661. Customer activity even processor can send customer events 661 (and/or data) to event processing rules engine 601. Customer activity event processor 602 can also store customer events 603 (and/or data) in the distributed database 606.

Event processing rules engine 601 can receive the customer events 661 (and/or data) from customer activity event processor 602. Event processing rules engine 602 can process customer events 661 to formulate synthetic events 662. Event processing rules engine 601 can send/export synthetic events 662 to social network connectors 611, syndicated rewards networks 621, CRM systems 631, or other systems 641. Event processing rules engine 601 can also store synthetic events 662 in distributed database 606.

Analytics 603 can access search and map reduce data 667 stored in distributed database 606. Analytics 603 can analyze data stored in distributed database 606 using a CXi calculation 613, recommenders 623, cluster analysis 633, and other analyses 643. Analytics 603 can store analysis results 666 (including recommendations at/from various management levels within an organization) in distributed database 606.

Visualization 604 can access search and map reduce data 664 stored in distributed database 606. Visualization 606 can present customer data using one or more of tableau 614, dashboards 624, 3D geospatial 634, and reports 644.

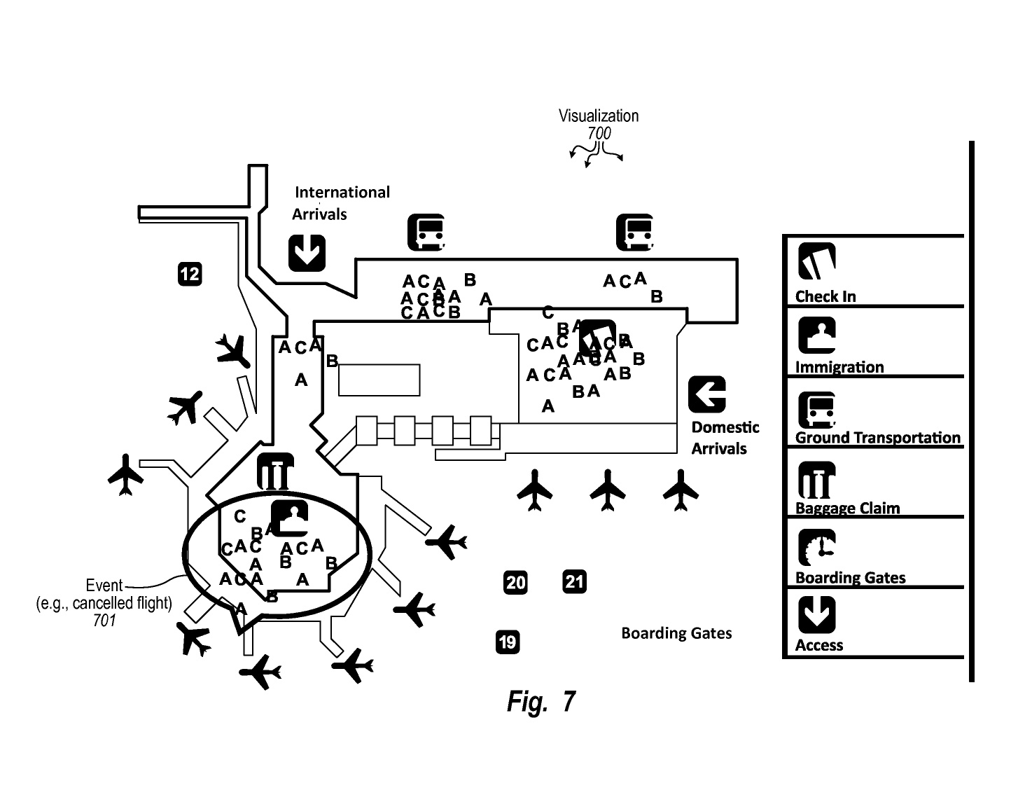

FIG. 7 illustrates an example visualization 700 of customer data. Visualization 701 depicts a portion of an airport terminal. The locations of various customers, indicated by one of: ‘a’, ‘b’, or ‘c’, are shown in the terminal. The use of ‘a’, ‘b’, and ‘c’ is used to segment customers based on one or more variables (e.g., based on frequent flier status tiers). For each customer in the terminal, the one or more variables can be submitted to a multi-variable algorithm used to segment the customer. The multi-variable algorithm can return an ‘a’, ‘b’, or ‘c’ based on the values of the one or more variables for the user.

Event 701, such as, for example, a cancelled flight, has occurred in a portion of the terminal. Event 701 negatively impacts customers included in the circular region. Based on the cancellation, messages can be sent to impacted customers. For example, an apology (an SMS message) can be sent to customer mobile devices (e.g., to an airline application). Depending on how the customer is segmented, the customer may also be given a reward as compensation. For example, customers with top tier frequent flier status can be given a free upgrade. If a customer receives a reward, a message indicating the reward can also be sent to the customer.

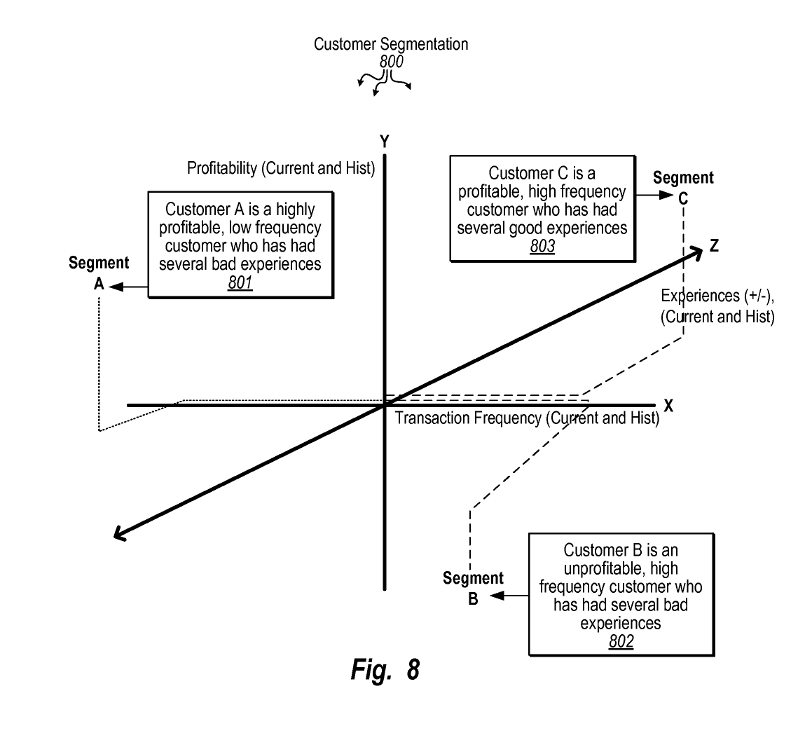

FIG. 8 illustrates an example of three dimensional graph of customer segmentation 800. Customer segmentation 800 uses a multi-variable algorithm to segment customers based on current and historical transaction frequency (the X-axis), current and historical profitability (the Y-axis), and current and historical negative and positive experiences (the Z-axis). Customer segments A, B, and C correspond to customer segments a, b, and c in visualization 700. Tailored messages and/or rewards can be sent to customers based on segment. For example, a customer in segment A is more likely to receive a better reward than a customer in segment B based on profitability and a desire to get a customer in segment A to become a higher frequency customer.

Embodiments of the invention can be implemented to improve CEM in sports arenas (ingress, luxury box services, etc.), casinos/hotels/cruise ships (personalize services for high value customers, room-entry, point-of-sale), theme parks (customer experience tracking, interactive experiences), retail (shopper traffic pattern analysis, location-based advertising/offers), etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, the computer system including system memory, one or more processors, and a database, a method for determining a customer reward, the method comprising:
accessing customer data from one or more customer inputs;
concentrating the customer data into one or more relevant customer events;
the processor formulating one or more synthetic events from the one or more relevant events;
the processor deriving an intelligent reward for at least one customer based on the one or more relevant events; and
storing the one or more synthetic events and the intelligent reward in the database.

2. The method of claim 1, wherein accessing customer data from one or more customer inputs comprises accessing customer data from one or more of: location services, surveys, customer relationship management systems, and point of sale systems.

3. The method of claim 1, wherein formulating one or more synthetic events from the one or more relevant events comprises formulating a synthetic event that provides a benefit to a customer.

4. The method of claim 1, wherein formulating a synthetic event that provides a benefit to a customer comprises tailoring the synthetic event for the customer based on the customer's inclusion in a particular segment of a customer base.

5. The method of claim 4, wherein tailoring the synthetic event for the customer based on the customer's inclusion in a particular segment of a customer base comprises tailoring the synthetic event for the customer based on the customer's profitability.

6. The method of claim 1, wherein deriving an intelligent reward for at least one customer based on the one or more relevant events comprises tailoring a reward for the customer based on the customer's inclusion in a particular segment of a customer base.

7. At a computer system, the computer system including system memory, one or more processors, and a database, a method for determining customer recommendations based on customer events associated with an organization, the method comprising:
accessing customer data from the database, the customer data representing individual events for one or more customers of a customer base;
the processor formulating analysis results by analyzing the accessed data using one or more of: a customer experience index, data mining, and ad hoc queries;
the processor generating trend data for a plurality of different segments of the customer base from the analysis results, the customer base segmented using a multi-variable algorithm based on the values for a plurality of different variables provided to the multi-variable algorithm;
providing a recommendation for at least one customer based on individual events and trend data for the at least one customer, the at least one customer selected from among the one or more customers of the customer base; and
storing the recommendation in the database.

8. The method of claim 7, further comprising generating real-time data and time lapse data for the plurality of different segments of the customer base from the analysis results.

9. The method of claim 8, wherein providing a recommendation for at least one customer comprises presenting one or more of: the real-time, the trend data, and the time lapse data for the plurality of different segments of the customer base.

10. The method of claim 8, wherein the plurality of different variables include one or more of: profitability, frequency, current experiences with an organization, and historical experiences with the organization.

11. The method claim 8, wherein providing a recommendation for at least one customer comprises providing a recommendation to give a customer one of: a synthetic event or a reward.

12. The method of claim 11, wherein providing a recommendation to give a customer one of: a synthetic event or a reward comprises providing a recommendation to a customer one of: a tailored synthetic event or a tailored reward based on the customer being included in a particular customer segment, the particular customer segment being selection from among the plurality of different segments of the customer base, the a tailored synthetic event or a tailored reward being tailored for the particular customer segment and differing from recommendations for other customer segments.

13. The method of claim 8, further comprising the multi-variable algorithm segment the customer base based on the values for a plurality of different variables provided to the multi-variable algorithm.

14. The method of claim 13, wherein the plurality of different variables include profitability, frequency, current experiences with the organization, and historical experiences with the organization

15. A customer experience management (CEM) system for an organization, the customer experience management (CEM) comprising:
one or more processors;
system memory;
a distributed database;
a customer activity event module;
an event processing rules engine;
wherein the customer activity event module is configured to:
access customer data from one or more inputs;
concentrate the customer data into one or more relevant customer events; and
send the one or more relevant events to the event processing rules engine; and
store the one or more relevant events to the distributed database;
wherein the event processing rules engine is configured to:
receive the one or more relevant events from the customer activity event module;
formulate one or more synthetic events from the one or more relevant events;
derive an intelligent reward for at least one customer based on the one or more relevant events; and
store the one or more synthetic events and the intelligent reward in the distributed database;

16. The customer experience management (CEM) system of claim 15, further comprising analytics, wherein the analytics are configured to:
access data from the distributed database;
analyze the accessed data using one or more of a customer experience index, data mining, and ad hoc queries;
generate trend data from the accessed data;
provide a recommendation for at least one customer based on individual events or trend data for the at least one customer; and
store analysis results in the distributed database.

17. The customer experience management (CEM) system of claim 16, further comprising a visualizer, wherein the visualizer is configured to:
access data from the distributed database; and
present one or more of: real-time, trend data, and time lapse data for a plurality of different segments of a customer base, wherein the customer based is segmented using a multi-variable algorithm based on the values for a plurality of different variables provided to the multi-variable algorithm as input.

18. The customer experience management (CEM) system of claim 17, wherein the analytics being configured to provide a recommendation for at least one customer comprises the analytics being configured to provide a recommendation for a synthetic event tailored to the at least one customer based on the customer being including in a particular segment of the customer base, particular segment of the customer base selected from among plurality of different segments of a customer base.

19. The customer experience management (CEM) system of claim 17, wherein the analytics being configured to provide a recommendation for at least one customer comprises the analytics being configured to provide a recommendation for a reward tailored to the at least one customer based on the customer being including in a particular segment of the customer base, particular segment of the customer base selected from among plurality of different segments of a customer base.

20. The customer experience management (CEM) system of claim 17, wherein the plurality of different variables includes two or more of: profitability, frequency, current experiences with the organization, and historical experiences with the organization.
